(19) United States
(12) Patent Application Publication
(10) Pub. No.: US 2010/0266983 A1
(43) Pub. Date: Oct. 21, 2010

(54) DEVICE FOR LOOSENING OR EXTRACTING A WISDOM TOOTH

(76) Inventors: Tze Chuen Ng, Hong Kong (CN); Sui Man Ko, Hong Kong (CN)

Correspondence Address: JONES DAY, 29TH FLOOR, EDINBURGH TOWER, THE LANDMARK,, 15 QUEEN'S ROAD, CENTRAL, HONG KONG, CN

(21) Appl. No.: 12/748,468

(22) Filed: Mar. 29, 2010

Related U.S. Application Data
(60) Provisional application No. 61/169,731, filed on Apr. 16, 2009.

(51) Int. Cl. A61C 3/00

(52) U.S. Cl. 433/114; 433/141

(57) ABSTRACT

A screw tap type device for loosening or extracting a wisdom tooth is provided. The device comprises a screw tap with a plurality of longitudinal cavities in the external screw thread, creating cutting teeth which create a strong frictional grip with a rough dentine wall of a previously drilled tapered tunnel of a wisdom tooth. A user can then twist the device to exert axial bodily dislocating force for easy loosening or extraction of the wisdom tooth.

### PRIOR RELATED APPLICATIONS

This application claims the benefit of U.S. Provisional Patent Application No. 61/169,731, filed Apr. 16, 2009, which is incorporated herein by reference in its entirety.

### FIELD OF THE INVENTION

The present invention relates to a screw tap type device for loosening or extracting a wisdom tooth. The tip of the screw tap comprises eight cavities formed on the outer surface of the screw tap. The remaining portions of the original screw thread form cutting teeth to provide sharp contact points between the screw tap and a tapered tunnel of the wisdom tooth previously prepared by drilling.

### BACKGROUND OF THE INVENTION

It is difficult to surgically extract a third molar, or a wisdom tooth, especially when it is a mesially-impacted lower wisdom tooth. Application of extraction forceps is difficult in deep seated angle of mandible, as the beaks of the forceps could hardly grip the remaining crown as the coronal surface must be deliberately sliced off mesially at an inclined angle to create space for maneuver. Application of elevators is also difficult as a pivot anchorage point for side lifting could hardly be found, even when the surrounding distal and buccal bones have been excessively relieved. Once the mesially sliced wisdom tooth is tightly gripped upon, movement can be facilitated and loosening or extraction of the wisdom tooth can be achieved readily.

It is a goal of the present invention to provide a screw tap type device for loosening or extracting mesially impacted lower wisdom teeth.

### SUMMARY OF THE INVENTION

The object of the present invention, providing a device for loosening or extracting a wisdom tooth, has been achieved by the methods and devices disclosed herein. In one aspect, a device with a handle for easy user control, a shaft which one of its ends is attached to the handle, and a screw tap which is attached to the other end of the shaft. The device comprises a plurality of turns of external screw thread and a plurality of longitudinal cavities formed in the external screw thread. The longitudinal cavities disconnect the external screw thread into pieces of discontinuous screw thread, or cutting teeth, which function as contact points with high adhesive force between the device and the wall of a previously drilled tapered tunnel of the wisdom tooth. In one embodiment, the handle, shaft and screw tap all constitute one single piece of equipment with no detachable parts. In some embodiments, the device comprises 12 turns of external screw thread and 8 longitudinal cavities forming 96 cutting teeth.

In another aspect, disclosed herein is a device with a handle for easy user control, a shaft which one of its ends is attached to the handle, and a screw tap which is attached to the other end of the shaft. The screw tap has an upper portion, which comprises a cylindrical protrusion constituting means for attaching the screw tap to the shaft, and a lower portion which comprises a plurality of turns of external screw thread and a plurality of longitudinal cavities formed in the external screw thread. In one embodiment, the device comprises 12 turns of external screw thread and 8 longitudinal cavities forming 96 cutting teeth.

In another aspect, disclosed herein is a device with a male hexagonal key and a spherical end with a female hexagonal slot and a screw tap. In one embodiment, the male hexagonal key is attached to a dental handpiece at one end, and is inserted into the female hexagonal slot at the other end. In another embodiment, the spherical end comprises at least a pair of flat facets opposite of each other on a horizontal plane, constituting means for gripping with fingers or other dental equipment. In a further embodiment, at the end of the spherical end furthest away from the female hexagonal slot, a screw tap comprising a plurality of turns of external screw thread and a plurality of longitudinal cavities formed in the external screw thread is attached. In a further embodiment, the spherical end comprises 4 flat facets equally distanced from each other on a horizontal plane, constituting means for gripping with fingers or other dental equipment. In a further embodiment, the spherical end comprises 12 turns of external screw thread and 8 longitudinal cavities forming 96 cutting teeth.

In another aspect, described herein is a method of loosening or extracting a wisdom tooth by drilling a tapered tunnel into the wisdom tooth, inserting into the tapered tunnel a screw tap which comprises a plurality of turns of external screw thread and a plurality of longitudinal cavities formed in the external screw thread, engaging the screw tap with the wisdom tooth by twisting, tightening, and gripping and wobbling either with fingers or with other dental equipment such as forceps. In one embodiment, the screw tap comprises 12 turns of external screw thread and 8 longitudinal cavities forming 96 cutting teeth.

### BRIEF DESCRIPTION OF THE FIGURES

Additional advantages and details of the invention are explained based on exemplary embodiments with reference to the drawings. The following are shown:

FIGS. 1a, 1b and 1c depict a side elevation view, an enlarged detail view and a front view, respectively, of the screw tap type device according to the present invention.

FIG. 2 depicts a side view of a mesially impacted lower wisdom tooth.

FIG. 3 depicts a side view of a mesially impacted lower wisdom tooth with its coronal surface of the crown sliced off.

FIG. 4 depicts a side view showing an example of a process for drilling a tapered tunnel into a wisdom tooth.

FIG. 5 depicts a side view of a mesially impacted lower wisdom tooth after drilling.

FIGS. 6a and 6b depict a side view and an enlarged detail view, respectively, showing an example of an application of the invention.

FIG. 7 depicts a side view of a distally impacted lower wisdom tooth.

FIGS. 8a, 8b and 8c depict a perspective view, a top view and a side view, respectively, of another embodiment of the invention.

FIGS. 9a and 9b depict a perspective view and a side view, respectively, of another embodiment of the invention.

FIG. 10 depicts a cross sectional view showing an example of a process of the application of another embodiment of the invention.

### DETAILED DESCRIPTION OF THE INVENTION

A device for loosening or extracting a wisdom tooth according to the present invention will be described below with reference to the figures.

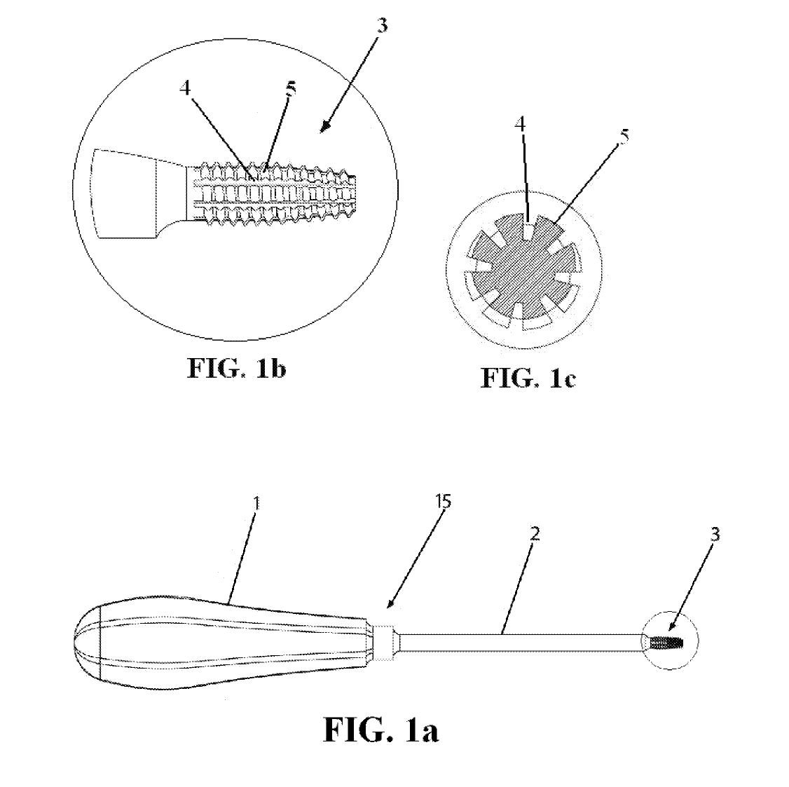

As illustrated in FIG. 1a, the screw tap type device shown generally comprises a shaft 2, which one of its end is attached to a handle 1, and the other end is attached to a screw tap 3. The handle, shaft and screw tap all constitute one single piece of equipment 15 with no detachable parts. As illustrated in FIGS. 1b and 1c, the screw tap comprises 12 turns of external screw thread and 8 longitudinal cavities 4 formed in the external screw thread. The longitudinal cavities 4 disconnect the external screw thread into 96 pieces of discontinuous screw thread, or cutting teeth 5.

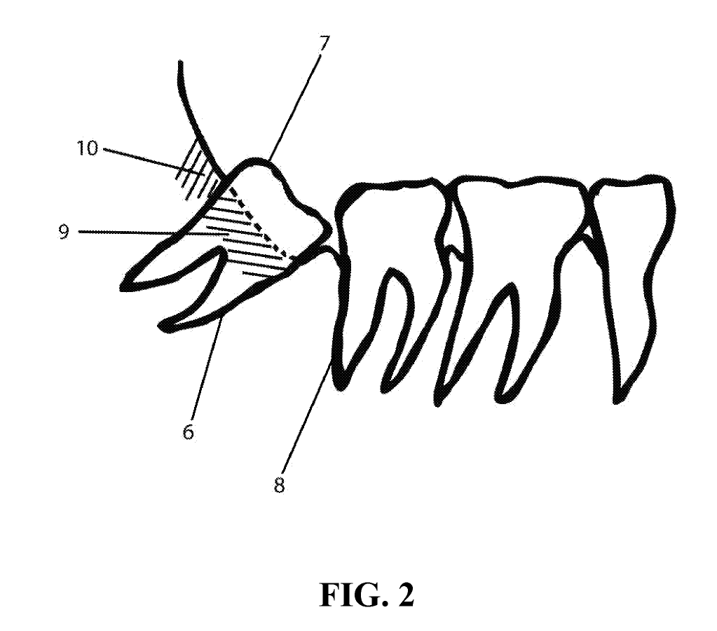

In FIG. 2, a side view of a mesially impacted lower wisdom tooth 6 is shown. The coronal crown of the wisdom tooth 7 is pressed against the second molar 8. Further obstructions creating difficulty in gripping by dental equipment include obstructions from the buccal bone 9 and the distal bone 10.

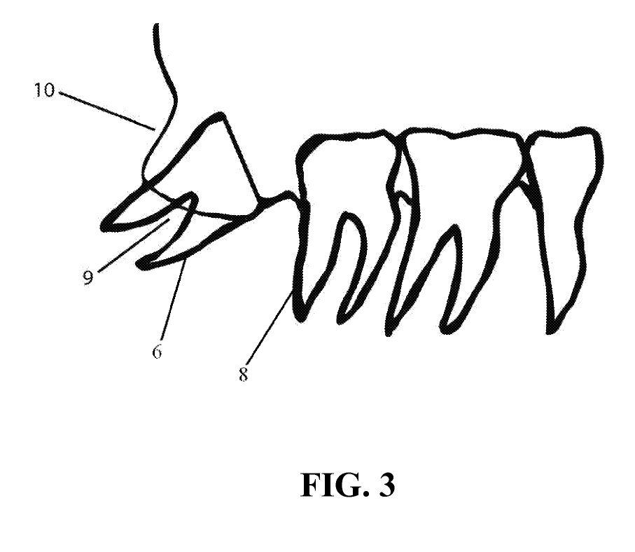

As illustrated in FIG. 3, to create space for maneuver in the distal and buccal regions, a portion of the buccal bone 9 and the distal bone 10 are commonly trimmed by conventional slow speed surgical burs. Further, the coronal crown of the wisdom tooth 7 is commonly sliced off at an inclined angle by a conventional high speed diamond bur to create space in the mesial region.

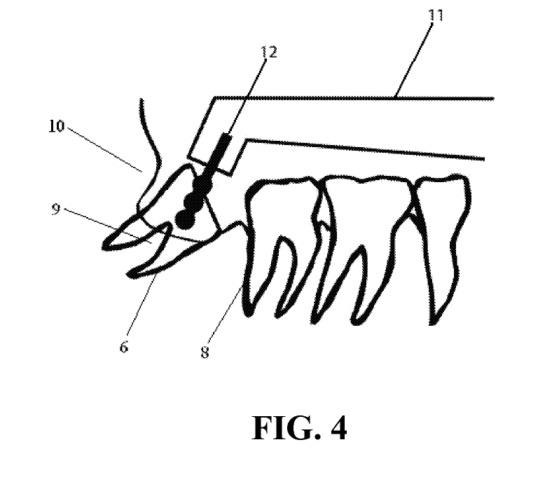

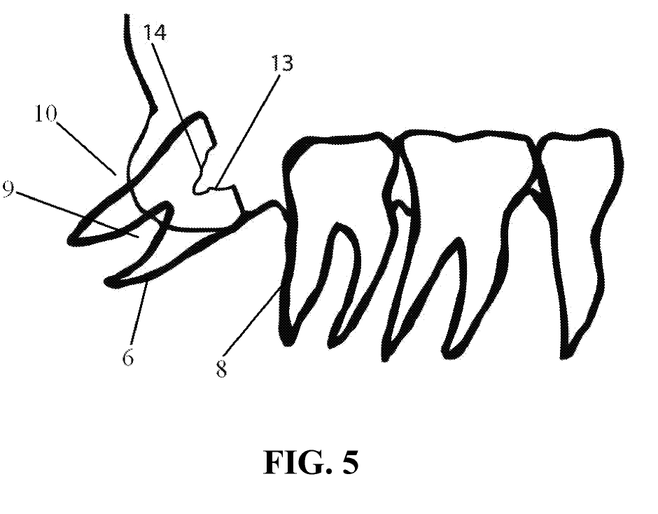

As illustrated in FIG. 4, a tapered tunnel may be prepared by a conventional high speed handpiece 11 with a large diamond beads-chained high speed bur 12 mounted thereon. The unconventional beads-chained bur 12 is excellent in this embodiment because, as illustrated in FIG. 5, it is capable of creating a rough dentine wall 13 which enhances the frictional grip anchorage by the screw tap 3. The tapered tunnel 14 is close to the dimensions of the screw tap 3, and tilted at an angle from the occlusal axis of the wisdom tooth 6.

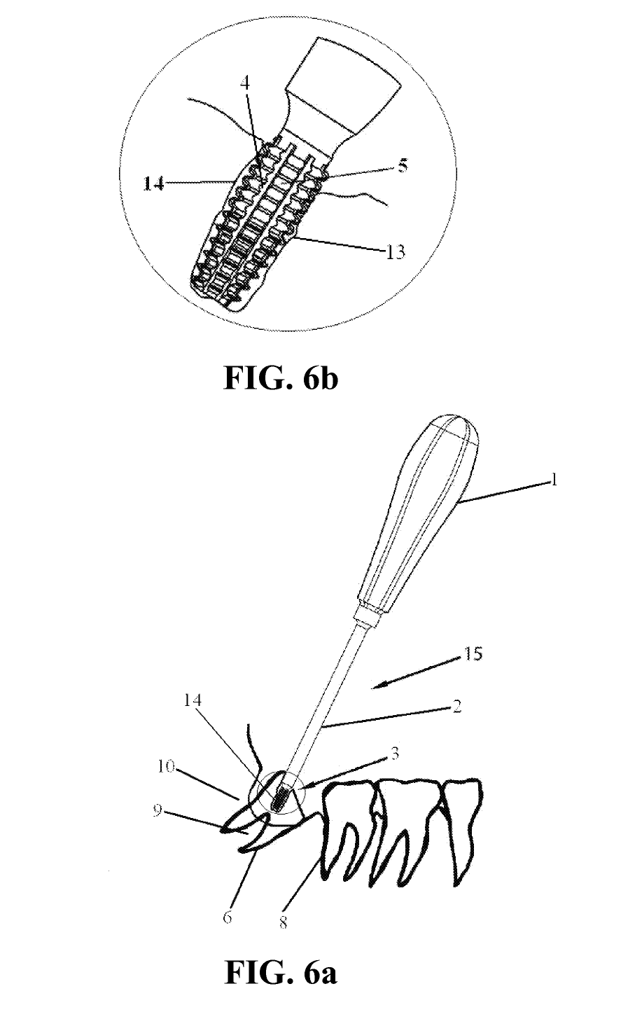

As illustrated in FIGS. 6a and 6b, the screw tap type device 15 comprising the handle 1, shaft 2 and screw tap 3 is inserted into the prepared tapered tunnel 14. The 96 cutting teeth 5 created by the longitudinal cavities 4 in the external screw thread contact with the rough dentine wall 13 of the tapered tunnel 14, and establish a strong frictional grip. Once the frictional grip is established, the user may twist the device with moderate force to initiate first bodily movement of the wisdom tooth 6. Once the first bodily movement of the wisdom tooth 6 is created, extraction shall be accomplished with much greater ease.

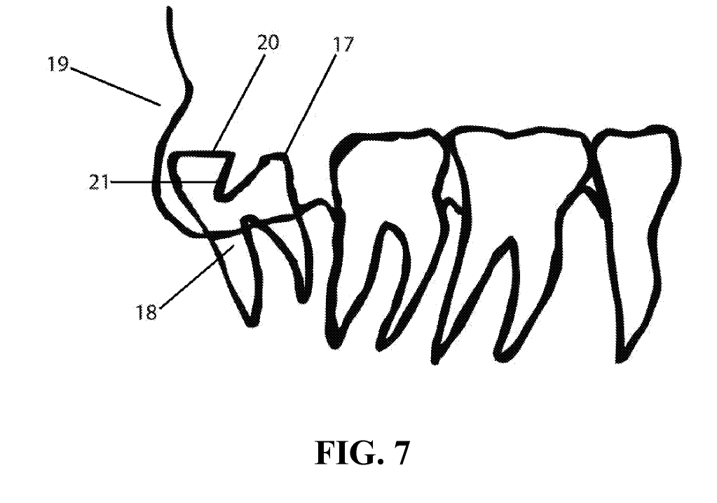

In another embodiment of the invention, as illustrated in FIG. 7, the device is used for a distally impacted lower wisdom tooth 17. To create space for maneuver, a portion of the buccal bone 18 and the distal bone 19 are commonly trimmed by conventional slow speed surgical burs. Further, the coronal crown of the distally impacted wisdom tooth 20 is commonly sliced off at an inclined angle by a conventional high speed diamond bur to create space in the distal region. A tapered tunnel 21 may be prepared by a conventional high speed handpiece 11 with a large diamond beads-chained high speed bur 12 mounted thereon as illustrated in FIG. 4.

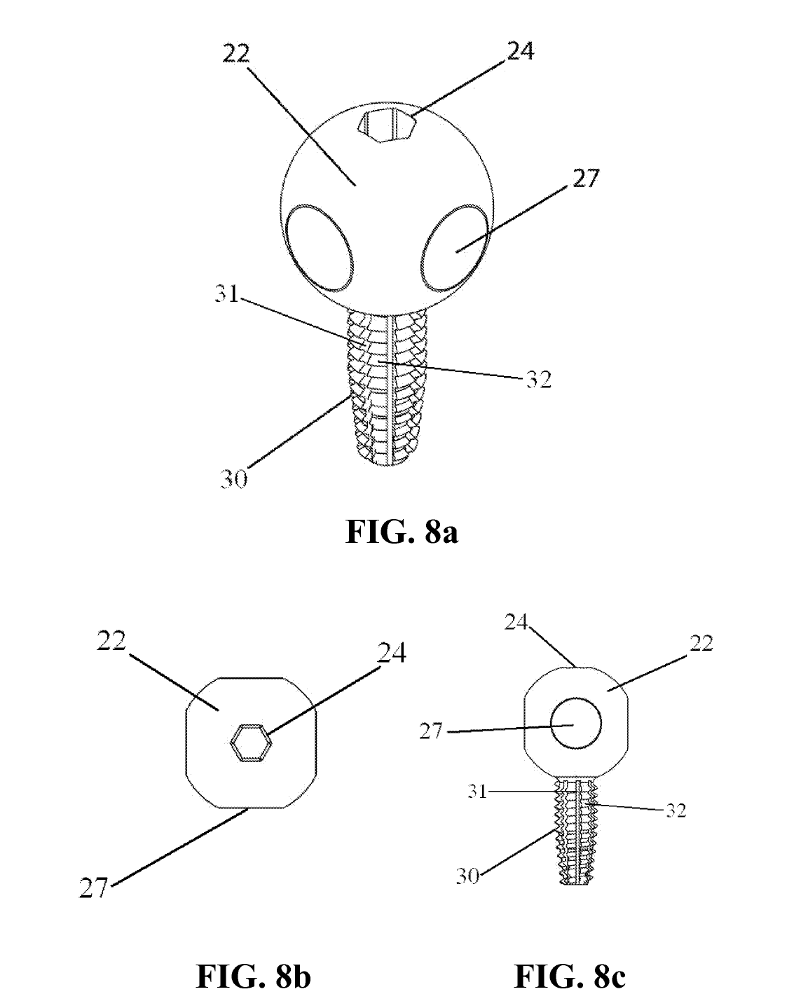

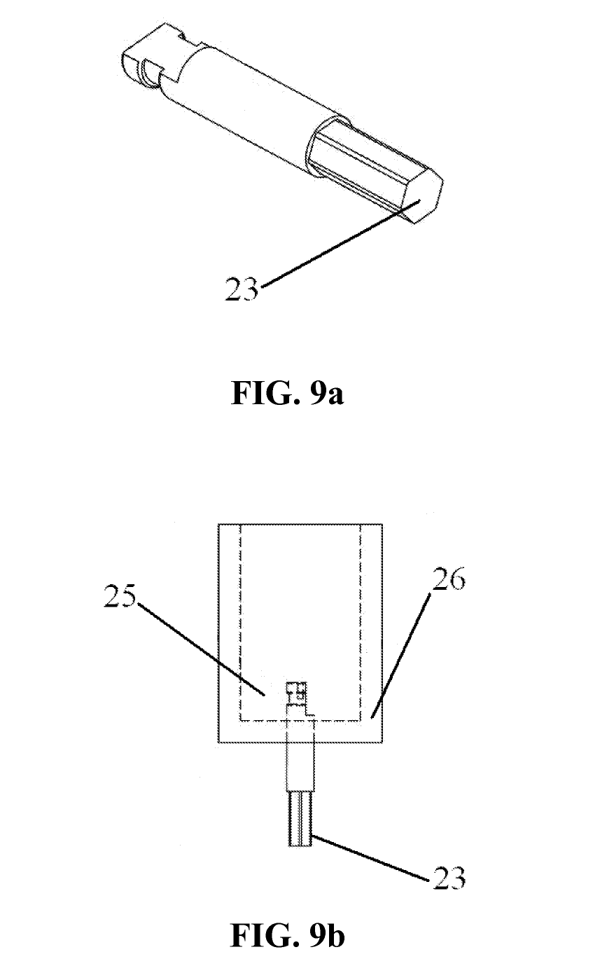

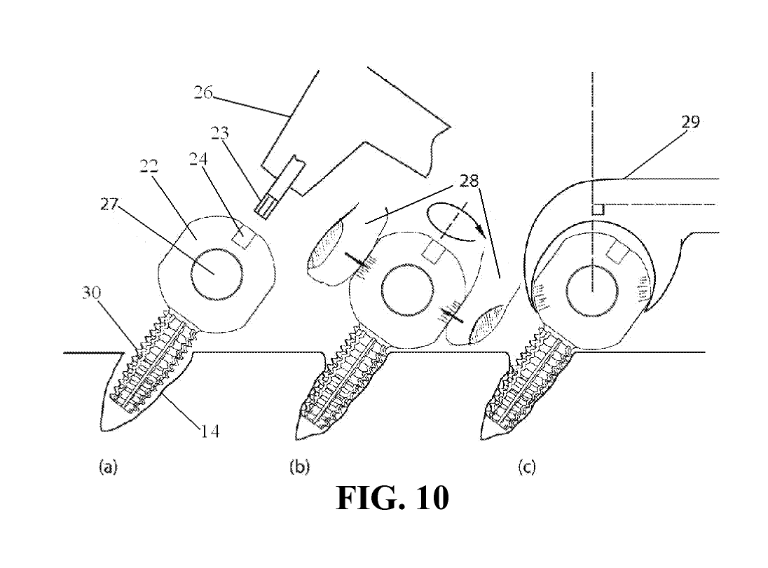

In another aspect of the invention, as illustrated in FIGS. 8a, 8b and 8c, a spherical end 22 is attached to a screw tap 30. On the spherical end 22, at the end furthest away from the point of attachment between the spherical end 22 and the screw tap 30 is a female hexagonal slot 24. A male hexagonal key 23, as illustrated in FIGS. 9a, 9b and 10, is inserted into the female hexagonal slot 24 at one end, and is attached to a deliver bur 25 at the other end, whereas the deliver bur 25 is in turn mounted on a slow speed high torque handpiece 26. The spherical end 22 also comprises 4 flat facets 27 equally distanced from each other on a horizontal plane. As illustrated in FIG. 10, the 4 flat facets 27 constitute means for gripping with fingers 28 or grappled by a forcep 29 to twist, tighten and wobble the device at desirable positions for extraction despite of its implant angle.

In some embodiments, the screw tap 3 or 30 comprises a plurality of turns of external screw thread. In some embodiments, the screw tap 3 or 30 comprises 12 turns of external screw thread.

In some embodiments, the screw tap 3 or 30 comprises a plurality of longitudinal cavities 4 or 31, respectively, formed in the external screw thread. In some embodiments, the screw tap 3 or 30 comprises 8 longitudinal cavities 4 or 31, respectively, formed in the external screw thread.

In some embodiments, the screw tap 30 and the spherical end 22 constitute 145 one single piece of equipment with no detachable parts.

In some embodiments, the male hexagonal key 23 and the female hexagonal slot 24 are in other suitable but non-spherical polygonal shapes, such as trigonal, tetragonal, pentagonal, heptagonal or octagonal, or other shapes such as straight-shaped, cross-shaped, star-shaped or other shapes suitable for the purpose of fitting the male hexagonal key 23 into the female hexagonal slot 24. In some embodiments, the male hexagonal key 23 and the female hexagonal slot 24 are in the shape of a polygon with more than 2 and fewer than 7 sides. In some embodiments, the male hexagonal key 23 and the female hexagonal slot 24 are in the shape of a hexagon.

In some embodiments, the screw tap 3 or 30 is coated with a material which has the effect of hardening the service of the screw tap 3 or 30. In some embodiments, the screw tap 3 or 30 is coated with titanium nitride for providing a hardened surface.

In some embodiments, the spherical end 22 comprises at least a pair of flat facets 27 opposite of each other on a horizontal plan. In some embodiments, the spherical end 22 comprises 4 flat facets 27 equally distanced from each other on a horizontal plane.

As various changes could be made in the methods and devices disclosed herein without departing from the scope of the invention, it is intended that all matter contained in the above description or shown in the accompanying figures shall be interpreted as illustrative and not in a limiting sense. For example, the methods and devices may be used for extracting lower or upper wisdom teeth, intact or fractured wisdom teeth, and mesially or distally impacted wisdom teeth.

What is claimed is:

1. A device for loosening or extracting a wisdom tooth, comprising:
a) a handle;
b) a shaft; and
c) a screw tap,
wherein the shaft is attached to the handle at one end and to the screw tap at the other end, and wherein the screw tap comprises a plurality of turns of external screw thread and a plurality of longitudinal cavities formed therein, the cavities forming disconnecting pieces of a discontinuous screw thread.

2. The device of claim 1, wherein the handle, shaft and screw tap all constitute one single piece of equipment.

3. The device of claim 1, wherein the screw tap comprises twelve turns of external screw thread.

4. The device of claim 1, wherein the screw tap comprises eight longitudinal cavities.

5. The device of claim 1, wherein the surface of the screw tap is coated with titanium nitride.

6. A device for loosening or extracting a wisdom tooth, comprising,
a) a male hexagonal key;
b) a spherical end; and
c) a screw tap,
wherein the spherical end comprises at least a pair of flat facets constituting means for gripping, and a female hexagonal slot at the end furthest away from the point of attachment between the spherical end and the screw tap, the female hexagonal slot and the male hexagonal key constituting means for attaching the spherical end to a dental handpiece, and wherein the screw tap comprises a plurality of turns of external screw thread and a plurality of longitudinal cavities formed therein, the cavities forming disconnecting pieces of a discontinuous screw thread.

7. The device of claim 6, wherein the spherical end comprises 4 flat facets equally distanced from each other.

8. The device of claim 6, wherein the screw tap comprises twelve turns of external screw thread.

9. The device of claim 6, wherein the screw tap comprises eight longitudinal cavities.

10. The device of claim 6, wherein the surface of the screw tap is coated with titanium nitride.

11. The device of claim 6, wherein the hexagonal slot and hexagonal key are hexagonal.

12. A method of exerting a dislocating force on a wisdom tooth, comprising the steps of:
a) drilling a tapered tunnel into a wisdom tooth;
b) inserting a screw tap of the device of any of claims 1-11 into the tapered tunnel;
c) engaging the screw tap with the wisdom tooth by twisting the screw tap into the tapered tunnel; and
d) loosening or extracting the wisdom tooth by the device.

13. The method of claim 12, wherein the wisdom tooth is a lower wisdom tooth.

14. The method of claim 12, wherein the wisdom tooth is mesially impacted.

15. The method of claim 12, wherein the drilling is carried out by using a high speed large diamond bur mounted on a high-speed dental handpiece.

16. The method of claim 12, wherein the drilling is performed by an unconventional beads-chained bur.

17. The method of claim 12, wherein the tapered tunnel is tilted at an angle from the occlusal axis of the wisdom tooth.

18. The method of claim 12, wherein the insertion of the screw tap is performed by attaching one end of a male hexagonal key into a female hexagonal slot of the spherical end of the device, wherein the male hexagonal key is attached to a high torque handpiece.

19. The method of claim 12, wherein the engagement of the screw tap is performed by manual twisting and tightening.

20. The method of claim 12, wherein the loosening or extracting of the wisdom tooth is performed by gripping and wobbling of the device.
